(19) United States
(12) Patent Application Publication
(10) Pub. No.: US 2002/0101397 A1
(43) Pub. Date: Aug. 1, 2002

(54) Liquid crystal display

(75) Inventors: Tomohide Ohira, Mobara (JP); Hiroshi Kurihara, Mobara (JP); Youichi Watanabe, Ooami (JP); Yasuhiko Yamagishi, Mobara (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 10/043,195

(22) Filed: Jan. 14, 2002

(30) Foreign Application Priority Data
Jan. 29, 2001 (JP) 2001-019910

(51) Int. Cl. G09G 3/36

(52) U.S. Cl. 345/87

(57) ABSTRACT

To enable easy modification or updating of the setup operation screen of a monitor while at the same time improving the user's operability. A liquid crystal display device includes a display signal recognition unit for recognizing a display signal or signals as sent from a display signal generation device, an adjustment unit operable in accordance with the adjustment content being displayed on the display signal generation device side for performing adjustment by recognition of a display signal pursuant to such adjustment content, and an adjustment content display unit for visually displaying on a screen the adjustment content due to this adjustment unit.

### BACKGROUND OF THE INVENTION

1. Field of the Invention

The present invention relates generally to liquid crystal display devices and, more particularly, to techniques adaptable for use in liquid crystal display monitors as employed while being connected with personal computers (referred to as “PCs” hereinafter).

2. Description of the Related Art

Currently available liquid crystal display monitors are generally designed to have on its monitor side one or more switches as required for execution of adjustment operations along with a means for visually displaying adjustment contents, thereby offering a capability to adjust the luminance and contrast and the like during displaying.

There are also known those having a means for recognizing a display signal or signal as sent from the display signal generation device side: in this case, these are arranged to display and recognize a display pattern pre-stored in a PC to thereby automatically perform adjustment of display positions and/or sampling clock phases or else.

Unfortunately, devices of the former type suffer from an inability for users to change or modify the design of a setup operation screen indicating adjustment contents. Thus, it should be required to individually change or update the operation screen design per se in accordance with every customer (on a usage-dependent basis).

Another problem faced with the related art is that in spite of the necessity for adjustment of more than one switch on the monitor device side, any pointing device such as a “mouse” is hardly usable, resulting in a decrease in operability.

In contrast, devices of the latter type are such that although in regard to start-up of the so-called automatic adjustment function these offer certain functionality for automatically determining or “judging” a pattern thereof, traditional architectures and specifications for operation of switches on the monitor device side are still employed therein with respect to the remaining adjustment operations. Consequently, the above-stated problems concerning the basic operability and operation screen design are kept unsolved.

### SUMMARY OF THE INVENTION

The invention was made in view of the above technical background, and its primary object is to provide a liquid crystal display device capable of improving the user operability while simultaneously enabling easy change or modification of operation screen design of a monitor.

A brief summary of a representative one of the inventive contributions of the invention as disclosed herein is as follows.

Specifically, a liquid crystal display device in accordance with the invention is the one that is characterized by comprising, for example, a display signal recognition unit for recognizing a display signal as sent from a display signal generation device side, an adjustment unit operable in accordance with an adjustment content being displayed on the display signal generation device side for performing adjustment by recognition of a display signal pursuant to such adjustment content, and an adjustment content display unit for visually displaying on a screen the adjustment content due to this adjustment unit.

The liquid crystal display device thus arranged is capable of readily constituting an adjustment screen in accordance with every customer or usage through mere change or alteration of a display pattern on the PC side; thus, it is possible to perform screen adjustment by use of a pointing device such as a mouse or else, for example.

And, since an adjustment content(s) is displayed on the screen upon execution of this screen adjustment, it becomes possible to recognize a present adjustment situation, which in turn makes it possible to improve the user's operability.

### BRIEF DESCRIPTION OF THE DRAWINGS

FIG. 1 is a block diagram of a liquid crystal display device for explanation of an arrangement of one embodiment of the liquid crystal display device in accordance with the invention;

FIG. 2 is a pictorial diagram for explanation of a system configuration of one embodiment of the liquid crystal display device in accordance with the invention;

FIG. 3 is an explanation diagram of one example of scanning lines for instruction of image adjustment data of a display screen;

FIG. 4 is a block diagram showing a configuration for image adjustment data recognition and screen adjustment;

FIG. 5 is a flow diagram for summarized explanation of an outline of the procedure for screen adjustment operations of the liquid crystal display device on the display signal generation device side; and

FIG. 6 is a flow diagram for summarized explanation of an outline of the procedure for screen adjustment operations of the liquid crystal display device on the liquid crystal display device side.

### DESCRIPTION OF THE PREFERRED EMBODIMENTS

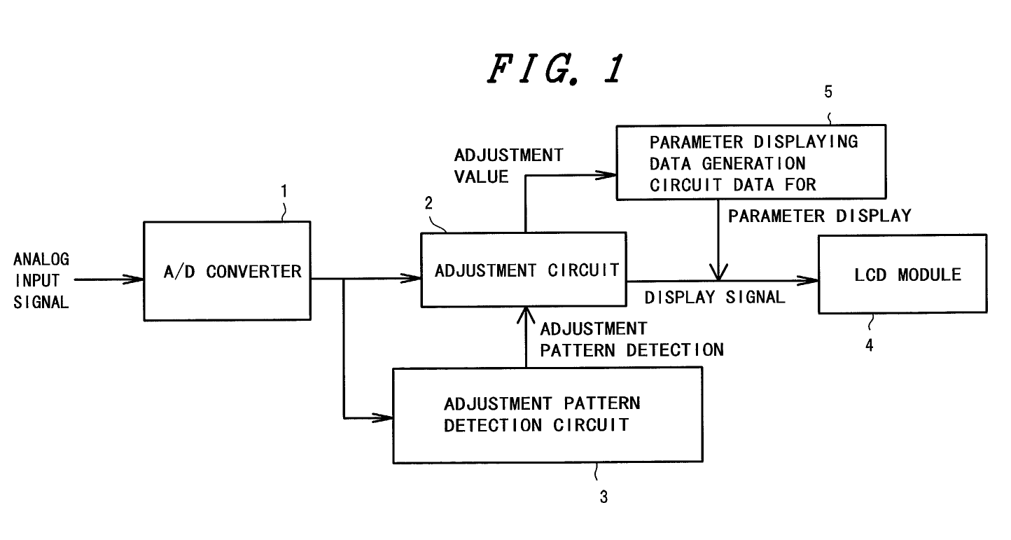

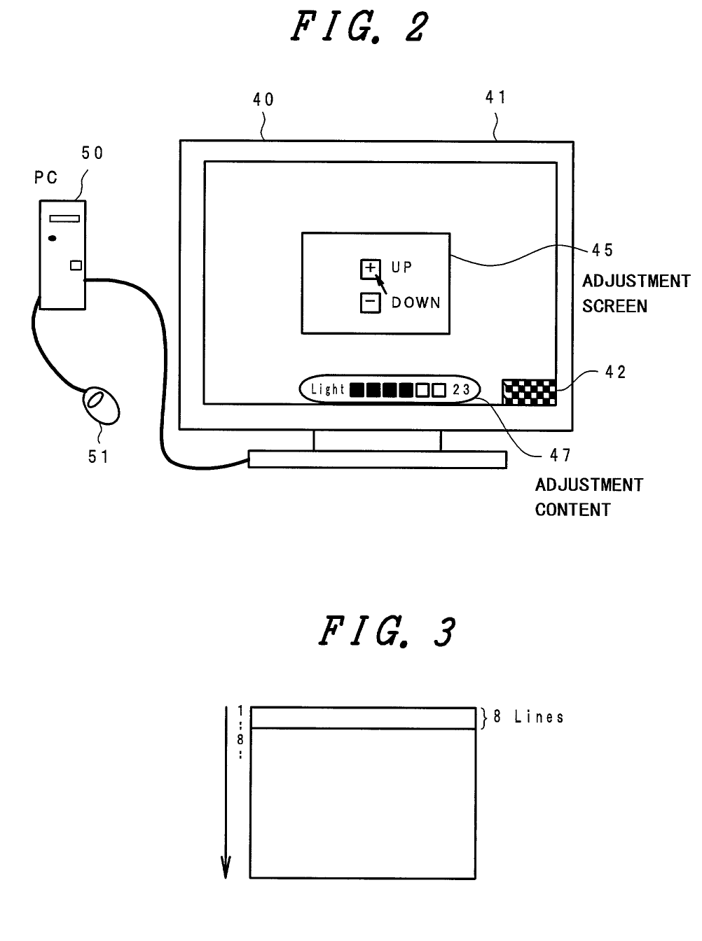

FIG. 1 is a block diagram of a liquid crystal display device for explanation of an arrangement of one embodiment of the liquid crystal display device in accordance with the invention, and FIG. 2 is a pictorial diagram for explanation of a system configuration of the embodiment, which is the embodiment in case display data is output from a PC in the form of an analog signal.

In this embodiment, what is done first is to determine an encoding method for recognizing that it is an adjustment pattern and also its position on a display screen. One example is that when a certain pattern comes at a lower right position on the screen, determination is made in such a way as to recognize it as an adjustment screen.

A software program has been pre-installed in the PC, which is capable of permitting simultaneous visualization of a display pattern used to adjust the luminance and contrast or else of a liquid crystal display monitor in combination with a pattern for recognition as the adjustment screen in accordance with the above doctrine and a device such as a mouse or the like.

When letting this software get started on the PC whenever adjustment is required, a pattern shown in FIG. 2 is generated on the PC and then sent forth toward the liquid crystal display monitor side. While referring to this pattern, a user moves one or more adjustment buttons (“UP” button, “DOWN” button) on a display window by use of the pointing device such as a mouse; then, an adjustment screen recognition pattern changes in a predefined way in accordance with such operation.

On the other hand, the monitor side is such that as shown in FIG. 1, analog display data is A/D-converted by an A/D converter 1 to generate digital display data, which will be sent via an adjustment circuit 2 toward an LCD module 4.

In addition, the digital display data will also be input to an adjustment pattern detection circuit 3. This adjustment pattern detection circuit 3 is operable to detect the above-noted adjustment screen recognition pattern for recognition of the operation content on the PC side and then perform adjustment in accordance therewith; thus, its output is to be sent to the adjustment circuit 2.

Additionally in this embodiment, a parameter display-use data generation circuit 5 is provided. This parameter display data generation circuit 5 operates to input from the adjustment circuit 2 a signal equivalent to an adjustment value and then output to the LCD module 4 a signal corresponding to parameter display-use data in response to such adjustment value.

To be brief, upon startup of the software for adjustment use on the PC whenever adjustment is required, an adjustment content 47 is to be displayed by the parameter display data generation circuit 5 in a manner as shown in FIG. 2.

Whenever the user operates an adjustment button(s) on an adjustment screen 45 through mouse-clicking or other similar suitable actions, a display pattern recognition region 42 is expected to respond thereto and change in a predefined way.

Additionally, when the user performs adjustment using the adjustment screen 45, the parameter display data generation circuit 5 is operatively responsive to such operation for generating and issuing parameter display-use data corresponding to an interface of the LCD module 4 on the basis of the adjustment value being output from the adjustment circuit 2.

This parameter display data will be over-written onto an output display signal of the A/D converter 1 and then visually displayed as the adjustment content 47 in a manner shown in FIG. 2.

In this embodiment, if the parameter display-use data generation circuit 5 were not provided, then, although recognition of a pattern from the monitor side is enabled, it is no longer possible to recognize any adjustment values within the monitor device on the PC side, which in turn makes it impossible to reflect any adjustment value on the PC's output display signal as the adjustment screen recognition pattern. Due to this, it is unable to display on the screen the adjustment range of any user's adjusted adjustment item(s) and a present adjustment value(s) on a real time basis, which causes the user to have to execute adjustment only by monitoring a change of the screen.

FIG. 3 is an explanation diagram of one example of scanning lines for instruction of pixel adjustment data of the display screen. With this embodiment, it is arranged to constitute 8-bit data with adjustment items and data for instruction of the adjustment value thereof being “mounted” on the first eight lines (1 to 8) of the scan lines.

More specifically, 8-bit code is arranged while letting a specific line of the above-stated eight lines associating with data other than black be “1” with the remaining lines be set at “0.” Let the upper 4 bits of this 8-bit code be adjustment items of the luminance or contrast or the like while letting the lower 4 bits be codes indicative of the adjustment values (brightness or alternatively contact values) thereof.

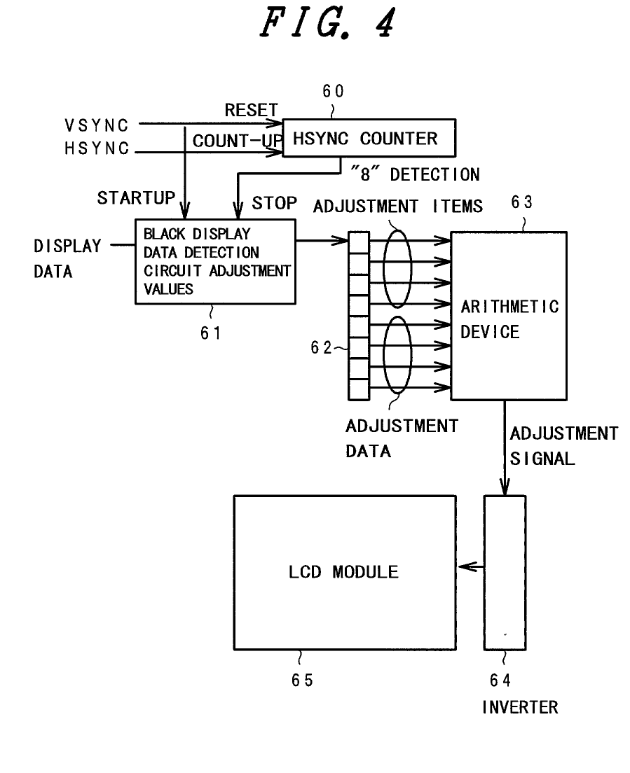

FIG. 4 is a block diagram for explanation of a configuration for image adjustment data recognition and screen adjustment. Sent out of the PC along with the display data are a vertical synchronization signal VSYNC and a horizontal sync signal SYNC. The above-noted 8-bit code detection is done by resetting a horizontal sync counter 60 by the vertical sync signal VSYNC as involved in the display data being sent from the PC. The horizontal sync counter 60 counts up horizontal sync signals HSYNC to be input thereafter.

Simultaneously the vertical sync signal VSYNC is used to make active or “activate” a black display data detection circuit 61. The horizontal sync counter 60 outputs a detection stop signal to the black display data detection circuit 61 at a time point that a value “8” has been counted.

The black display data detection circuit 61 attempts to determine whether black data is present or absent of a respective one of those lines covering from the line upon startup (first line) to the line upon termination (eighth line), and then sequentially latch and hold determination or “judgment” results at a judgment result holding shift register 62.

The judgment result holding shift register 62 has a 8-bit storage capacity and thus permits the adjustment items and their adjustment values to be latched at the upper 4-bits and lower 4-bits, respectively.

These 8-bit data segments are input to an arithmetic operational device 63 for computation of a specific adjustment item (for example, luminance) as instructed by the upper 4 bits along with the adjustment value thereof.

The resultant computed adjustment item and its adjustment value are supplied as a practical adjustment signal (here, a control signal of a current value of a backlight unit) to an inverter 64 for use as the backlight power supply of an LCD module 65.

The inverter 64 applies to the backlight a current pursuant to the adjustment signal as input thereto, thus setting up the brightness of the LCD module 65.

Setting of the above adjustment item and adjustment value is done in such a way that data of the lower 4 bits is set up by modification or updating of the adjustment buttons (UP button, DOWN button) of the adjustment screen 45 being presently displayed on a screen 41 of a liquid crystal display monitor set 40 in a manner as shown in FIG. 2.

Additionally an adjustment pattern as set up in accordance with the adjustment item (here, black-and-white diced or “checkered” pattern) is displayed at a portion of the screen 41 (here, at the lower right corner), which will change in brightness (luminance) in a predetermined way in response to an operation of the adjustment button that is modifiable through one or more operations of the mouse 51.

This adjustment pattern is created by a screen adjusting software program as has been installed in the PC. This screen adjustment software gets started upon selection of the screen adjustment program through clicking on a preset icon by way of example, for creation of a corresponding adjustment pattern upon selection of one from among the adjustment items being presently displayed as a list on an initial screen not shown, which pattern will then be sent toward the liquid crystal display device side.

Simultaneously during preparation of this adjustment pattern, the PC creates a pattern of the adjustment screen 45 in accordance with the selected adjustment item, which will then be sent to the liquid crystal display monitor set side.

The above-noted adjustment pattern being displayed in the display pattern recognition region 42 and the pattern of adjustment screen 45 may alternatively be such that the aforesaid screen adjustment software is prepared to enable the user to freely prepare them on the PC according to his or her preference.

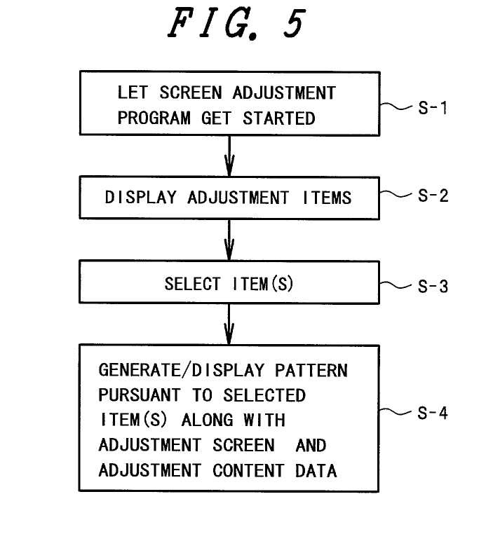

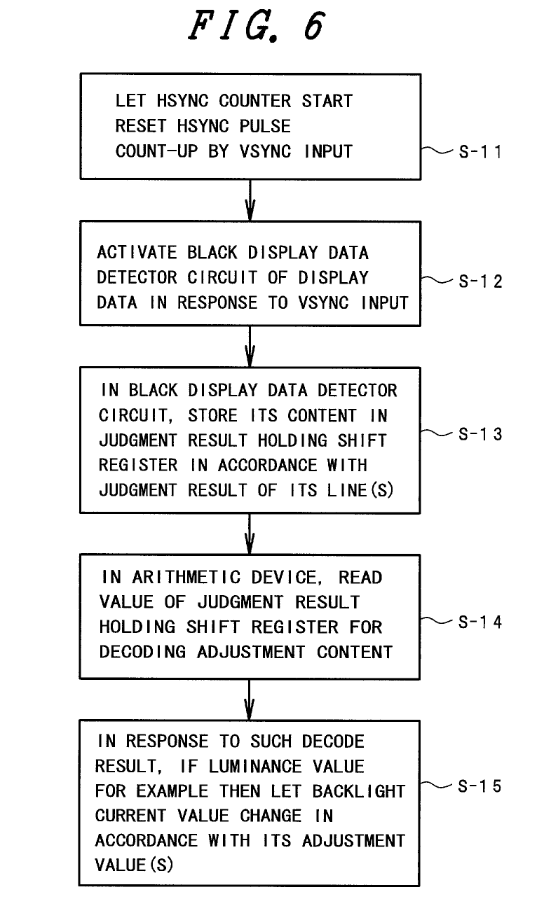

FIGS. 5 and 6 are flow diagrams for summarized explanation of an outline of the above-mentioned procedure for screen adjustment operations of the liquid crystal display device of the illustrative embodiment, wherein FIG. 5 shows a procedure on the display signal generator device (PC) side whereas FIG. 6 shows a procedure on the liquid crystal display monitor set side.

In FIG. 5, when performing screen adjustment, first let the PC's screen adjustment program get started (S-1); then, display as a menu respective screen adjustment items—for example, the luminance, contrast, sampling clock, color tone (color temperature, R, B, G alone), display position (upper and lower, right and left) and the like (S-2).

The user is now expected to select through operation of a mouse or keyboard one or more necessary adjustment items from among a plurality of adjustment items being presently displayed (S-3). Upon selection of an adjustment item or items, there are generated a pattern conforming to such adjustment item(s) to be displayed in the display pattern recognition region 42 of the screen of the liquid crystal display monitor set along with the adjustment screen 45 and adjustment content 47, which will then be transferred to the liquid crystal display monitor set side.

In FIG. 6, the adjustment screen 45 and adjustment content 47 plus the pattern to be displayed in the display pattern recognition region 42 that have been transferred from the PC are displayed with no changes added thereto at specific positions on the screen (refer to FIG. 2). On the other hand, the adjustment item(s) and adjustment value(s) thereof are such that the horizontal sync signal HSYNC is counted up to 8 lines in response to input of the vertical sync signal VSYNC in the way that has been shown in FIG. 3 and explained in conjunction with FIG. 4 (S-11).

Substantially simultaneously, activate the black display data detector circuit in response to input of the vertical sync signal VSYNC (S-12); then, determine whether black display data is present at the lines of from the first line to the eighth line; next, sequentially store judgment results in the judgment result holding shift register (S-13).

As shown in FIG. 4, the content as has been stored in the judgment result holding shift register 62 becomes 8-bit judgment data, wherein its upper 4 bits represent the adjustment items whereas the lower 4 bits indicate the adjustment values thereof.

Next, the arithmetic device operates to read and decode the 8-bit judgment data being stored in the judgment result holding shift register (S-14). In accordance with a decoded result, if such adjustment item(s) is for luminance adjustment by way of example then let the inverter use the adjustment value(s) thereof to control changing the value of a current being supplied to the backlight, resulting in accomplishment of screen luminance (brightness) adjustment.

Any adjustment value is modifiable or alterable through operation of the adjustment buttons (UP button, DOWN button) as displayed within the adjustment screen 45 shown in FIG. 2 by using a mouse or else: the modified or “updated” adjustment values will be reflected to the lower 4 bits of the 8-bit data stated supra. And, a certain adjustment content 47 that is the content pursuant to such modification will be displayed.

The user is now permitted to set into an optimal luminance state through operation of the adjustment buttons (UP button, DOWN button) by using a mouse or else while at the same time looking at the pattern being presently displayed in the display pattern recognition region 42 on the screen of the liquid crystal display monitor set. Thereafter, click on an “End” button or alternatively “OK” button (both are not depicted), thereby terminating the adjustment operation.

Although in the above-stated embodiment the adjustment screen recognition code is data at the lower right portion of the screen, similar ones may be provided at a plurality of portions of the screen or alternatively a code which permits arithmetic operation with other display data is employable, which in turn makes it possible to avoid any possible inconveniences including, but not limited to, erroneous adjustment with respect to a display pattern that is not the adjustment screen.

It should also be noted that although one specific case where the input signal from the PC is an analog signal has been shown, similar results are still obtainable by execution of similar operations even if it is a digital signal.

According to the liquid crystal display device in accordance with the above-stated embodiment, it becomes possible even for the same monitor set to readily constitute an appropriate adjustment screen in a way pursuant to its usage, by merely changing or modifying a display pattern on the PC side.

Another advantage lies in an ability to adjust monitor circuitry by use of a pointing device such as a mouse while at the same time increasing recognizability of the situation of adjustment being presently executed.

As is apparent from the foregoing explanation, in accordance with the liquid crystal display device incorporating the principles of the invention, it is possible to provide a liquid crystal display device capable of improving the user's operability while simultaneously enabling easy modification of the design of a setup operation screen of a monitor.

What is claimed is:

1. A liquid crystal display device comprising:
a display signal recognition unit for recognizing a display signal as sent from a display signal generation device side;
an adjustment unit operable in accordance with an adjustment content being displayed on the display signal generation device side for performing adjustment by recognition of a display signal pursuant to such adjustment content; and
an adjustment content display unit for visually displaying on a screen the adjustment content due to this adjustment unit.

2. The liquid crystal display device according to claim 1, wherein the adjustment content to be displayed includes either more than one character or numerical value.
